(19) United States
(12) Patent Application Publication
(10) Pub. No.: US 2010/0313254 A1
(43) Pub. Date: Dec. 9, 2010

(54) TRANSCEIVING ADAPTER AND TRANSMITTING AND RECEIVING METHOD FOR WIRELESS NETWORK

(75) Inventor: PEI-WUA WU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/499,735

(22) Filed: Jul. 8, 2009

(30) Foreign Application Priority Data
Jun. 9, 2009 (CN) 200910303084.5

(51) Int. Cl. H04L 9/32; G06F 11/32

(52) U.S. Cl. 726/7; 714/49; 714/E11.18

(57) ABSTRACT

A transceiving adapter for wireless network includes a transmitting and receiving module, a microprocessor module, an alarm module, and an input/output module. The transmitting and receiving module is to receive network signals from network and output the network signals to the microprocessor module, and receive an output signal from a computer via the microprocessor module and send the output signal to an access point. When the network signals are unstable, the microprocessor module outputs an alarm signal. When the network signals are stable, the microprocessor module outputs a control signal. The alarm module receives the alarm signal from the microprocessor module and outputs an alarming sound according to the alarm signal. The input/output module receives the control signal from the microprocessor and outputs the network signals to the computer according to the control signal.

### BACKGROUND

1. Technical Field

The present disclosure relates to wireless network systems, and particularly, to a transceiving adapter and a transmitting and receiving method for wireless network.

2. Description of Related Art

A wireless communication system adapted for use in homes or office buildings generally includes an access point coupled to an interactive data network (e.g., the Internet) through a high-speed connection. A portable computer in a house may include a wireless transceiving adapter that allows the portable computer to receive and transmit data via the access point. However, factors, such as location, distance, and signal intensity etc., may cause network signals to be unstable.

### BRIEF DESCRIPTION OF THE DRAWINGS

FIG. 1 is a schematic diagram of an embodiment of a transceiving adapter communicating with a computer.

FIG. 2 is a block diagram of an embodiment of the transceiving adapter and the computer of FIG. 1.

FIG. 3 is a flowchart of an embodiment of a transmitting and receiving method for wireless network.

### DETAILED DESCRIPTION

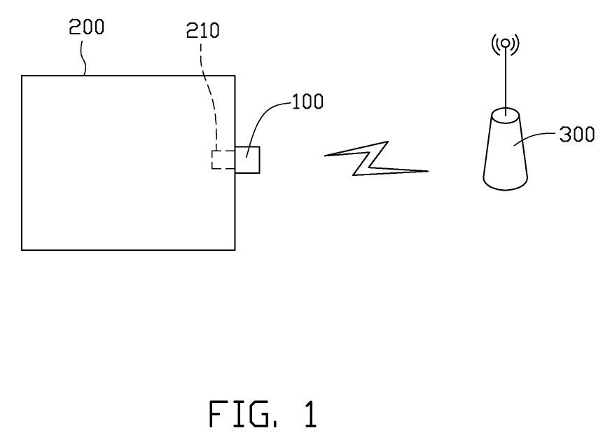

Referring to FIG. 1, a transceiving adapter 100 for a wireless network is connected to a computer 200, to allow the computer 200 to access a wireless network through the transceiving adapter 100. The computer 200 includes an interface 210, such as an universal serial bus (USB) interface. The transceiving adapter 100 is electrically connected to the network interface 210 of the computer 200 to communicate with the computer 200.

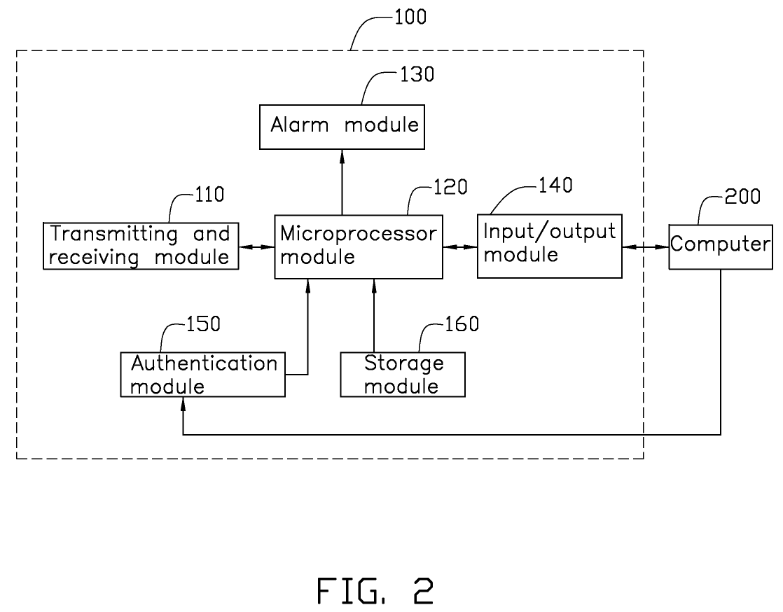

Referring to FIG. 2, an exemplary embodiment of the transceiving adapter 100 includes a transmitting and receiving module 110, a microprocessor module 120, an alarm module 130, an input/output module 140, an authentication module 150, and a storage module 160. Each module of the transceiving adapter 100 is made of computer programs and/or circuits.

The transmitting and receiving module 110 receives network signals from an access point 300 (the access point 300 provides a point of connection for wireless communication devices, such as a transceiving adapter where the transceiving adapter may communicate to the access point), and sends the network signals to the microprocessor module 120. The transmitting and receiving module 110 also receives output signals from the computer 200 via the microprocessor module 120, and sends the output signals to the access point 300.

The microprocessor module 120 receives the network signals via the transmitting and receiving module 110 and processes the network signals. When the network signals are unstable, the microprocessor module 120 outputs a first alarm signal to the alarming module 130. When the network signals are stable, the microprocessor module 120 outputs a control signal to the input/output module 140.

The alarm module 130 receives the first alarm signal from the microprocessor module 120 to output an alarm, such as an audible alarm, according to the first alarm signal.

The input/output module 140 receives the control signal from the microprocessor module 120 and outputs the network signals received by the transmitting and receiving module 110 to the computer 200, according the control signal. Therefore, the computer 200 can access the wireless network.

The storage module 160 stores status information of a user account of the computer 200, such as a password, an image, or a fingerprint.

The authentication module 150 receives identification information inputted to the computer 200 and sends the received identification information to the microprocessor module 120. The microprocessor module 120 reads the validation information of the storage module 160 and compares the validation information with the identification information of the user. If the identification information matches with the validation information, the status of the user account is authenticated, the microprocessor module 120 outputs an instruction signal to the computer 200 via the input/output module 140, to output a removing signal to remove the transceiving adapter 100 from the computer 200. As a result, the transceiving adapter 100 can then be safely removed from the computer 200. If the identification information is different from the validation information, the status of the user account is not authenticated, the microprocessor 120 outputs a second alarm signal to the alarm module 130, to output an audible alarm.

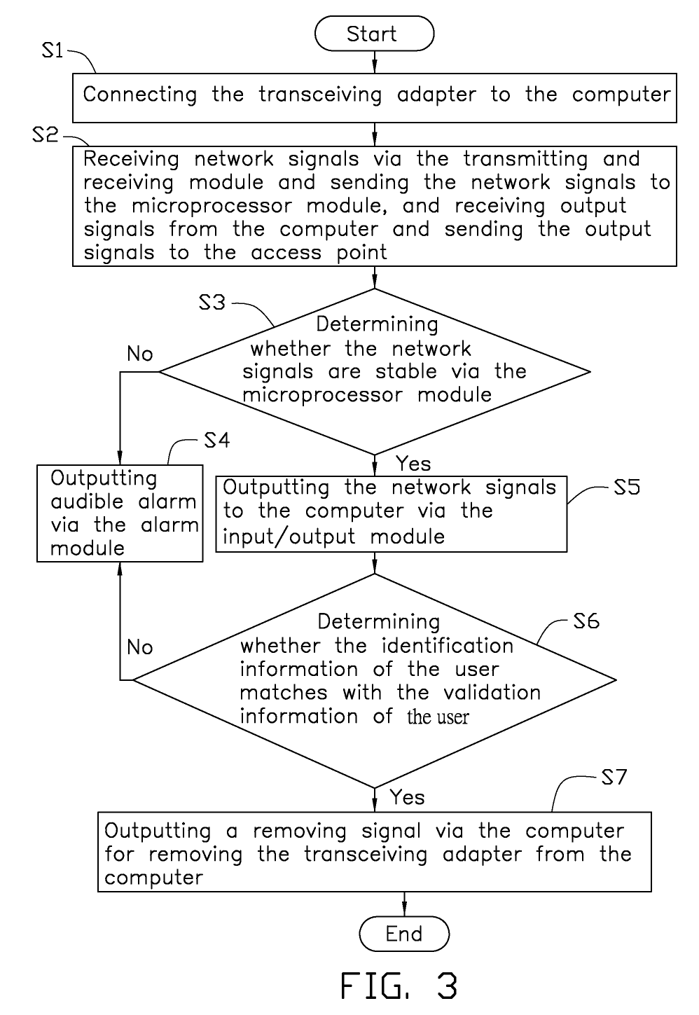

Referring to FIG. 3, an exemplary embodiment of a transmitting and receiving method for a wireless network includes the following steps.

In step S1, the transceiving adapter 100 is connected to the computer 200 via the interface 210, to allow the computer 200 to access the wireless network via the transceiving adapter 100.

In step S2, the transmitting and receiving module 110 receives network signals from the wireless network and sends the network signals to the microprocessor module 120, and sends output signals from the computer 200 via the microprocessor module 120 to the access point 300.

In step S3, the microprocessor module 120 receives the network signals via the transmitting and receiving module 110 and determines whether the network signals are stable, if the network signals are unstable, the procedure goes to the step S4, if the network signals are stable, the procedure goes to step S5.

In step S4, the microprocessor module 120 outputs a first alarm signal to the alarm module 130, to output an audible alarm according to the first alarm signal.

In step S5, the microprocessor module 120 outputs a control signal to the input/output module 140, to output the network signals received by the transmitting and receiving module 110 to the computer 200.

In step S6, the authentication module 150 receives identification information inputted to the computer 200 and send the received identification information to the microprocessor module 120, the microprocessor module 120 reads the validation information of the storage module 160 and compares the validation information with the identification information of the user, to determine whether the identification information matches with the validation information of the user. If the identification information matches with the validation information, the procedure goes to step S7. If the identification information does not match with the validation information, the procedure goes back to step S4.

In step S7, the status of the user passes, the microprocessor module 120 outputs an instruction signal to the computer 200 via the input/output module 140, to output a removing signal to remove the transceiving adapter 100 from the computer 200.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A transceiving adapter, comprising:
a microprocessor module;
a transmitting and receiving module to receive network signals from a wireless network and output the network signals to the microprocessor module, and to receive output signals from a computer via the microprocessor module and send the output signals to an access point;
an alarm module to receive a first alarm signal from the microprocessor module in response to the network signals being unstable, and output an alarm according to the first alarm signal; and
an input/output module to receive a control signal from the microprocessor in response to the network signals being stable, and output the network signals to the computer according to the control signal.

2. The transceiving adapter of claim 1, further comprising:
a storage module to store status information of a user of the computer; and
an authentication module to receive identification information of a user inputted to the computer and send the received identification information to the microprocessor module, wherein the microprocessor module reads validation information of the storage module and compares the validation information with the identification information to determine whether the identification information and the validation information of the user are identical.

3. The transceiving adapter of claim 2, wherein the microprocessor module outputs an instruction signal via the input/output module to a computer connecting the transceiving adapter, to remove the transceiving adapter from the computer, in response to the validation information and the identification information being identical; wherein the microprocessor module outputs a second alarm signal to the alarm module, in response to the validation information and the identification information being not identical.

4. The transceiving adapter of claim 2, wherein the validation information of the user comprises a password set by the user.

5. The transceiving adapter of claim 2, wherein the validation information of the user comprises an image set by the user.

6. The transceiving adapter of claim 2, wherein the validation information of the user comprises a fingerprint set by the user.

7. A transmitting and receiving method for transmitting network signals between an access point and a computer via a transceiving adapter, the transmitting and receiving method comprising:
receiving network signals from the network via a transmitting and receiving module and sending the network signals to a microprocessor module, and receiving output signals from the computer via the microprocessor module and sending the output signals to the access point;
receiving the network signals from the transmitting and receiving module and determining whether the network signals are stable;
outputting a first alarm signal in response to the network signals being unstable; and
outputting a control signal to output the network signals received by the transmitting and receiving module to the computer, in response to the network signals being stable.

8. The transmitting and receiving method of claim 7, further comprising: identification information of a user inputted to the computer, and comparing the identification information of the user with the validation information, to determine whether the identification information of the user match with the validation information.

9. The transmitting and receiving method of claim 8, still further comprising: the status of the user passing, and outputting an instruction signal to a computer connecting the transceiving adapter to remove the transceiving adapter, in response to the identification information match with the validation information.

10. The transmitting and receiving method of claim 8, still further comprising: the status of the user not passing, and outputting a second alarm signal, in response to the identification information not match with the validation information.

11. The transmitting and receiving method of claim 8, wherein the status information of the user may comprise at least one of a password, an image, and a fingerprint of the user.
